(19) United States
(12) Patent Application Publication
(10) Pub. No.: US 2007/0251753 A1
(43) Pub. Date: Nov. 1, 2007

(54) HYDRAULIC STEERING

(75) Inventor: Martin Clausen, Bjerringbro (DK)

Correspondence Address: MCCORMICK, PAULDING & HUBER LLP, CITY PLACE II, 185 ASYLUM STREET, HARTFORD, CT, 06103, US

(73) Assignee: Sauer-Danfoss ApS, Nordborg (DK)

(21) Appl. No.: 11/740,370

(22) Filed: Apr. 26, 2007

(30) Foreign Application Priority Data
Apr. 28, 2006 (DE) 10 2006 019 804.2

(51) Int. Cl. B62D 7/00

(52) U.S. Cl. 180/414

(57) ABSTRACT

The invention concerns a hydraulic steering with a steering motor arrangement, a steering valve arrangement and a pressure supply comprising a first pump and a second pump. It is endeavoured to perform a change between the supplies by the pumps as unperceived as possible. For this purpose, the steering valve arrangement (4) is connected to the first pump (6) through a valve (8) with pressure compensation function and to the second pump (19) through a compensation valve (26).

### CROSS REFERENCE TO RELATED APPLICATIONS

Applicant hereby claims foreign priority benefits under U.S.C. § 119 from German Patent Application No. DE 10 2006 019 804.2 filed on Apr. 28, 2006, the contents of which are incorporated by reference herein.

### FIELD OF THE INVENTION

The invention concerns a hydraulic steering with a steering motor arrangement, a steering valve arrangement and a pressure supply comprising a first pump and a second pump.

### BACKGROUND OF THE INVENTION

Such a hydraulic steering is known from, for example, DE 101 59 297 A1. Each pump supplies its own steering valve, and each steering valve is connected to a steering motor. This provides two steering circuits. If an error occurs in one of the steering circuits, this steering circuit is deactivated and the other steering circuit is activated. For this purpose, it is necessary to change over a valve in each steering circuit. An exactly simultaneous change-over, however, involves unjustifiably large efforts, so that the driver of a vehicle having such a steering will feel the change-over and in some cases be bothered by it.

The hydraulic steering of the present invention is also called “steer-by-wire”. Usually, in this connection, a mechanical, active connection no longer exists between a steering member, for example a steering handwheel, and the steering motor that eventually deflects the wheels. Accordingly, a high degree of safety must be available, and it is endeavoured to provide this safety by means of two or more pumps.

### SUMMARY OF THE INVENTION

The invention is based on the task of making a change-over of the supply from the pumps as unperceived as possible.

With a hydraulic steering as mentioned in the introduction, this task is solved in that the steering valve arrangement is connected to the first pump through a valve with pressure compensation function and to the second pump through a compensation valve.

Thus, the steering of the vehicle still takes place via the steering valve arrangement, which is supplied by one of the two pumps. If the first pump is used, the valve between the first pump and the steering valve arrangement has a pressure compensation function, that is, the valve ensures that the pressure drop across the steering valve arrangement remains the same. Among other things, this has the effect that the flow of the hydraulic fluid supplied to the steering motor arrangement now only depends on the position of the steering valve arrangement. Thus, the pressure of the first pump is not important, as long as the pressure supplied by the first pump is sufficiently high. As also the second pump supplies the steering valve arrangement through a compensation valve, a failure of the first pump will not make the second pump control the pressure drop across the steering valve arrangement directly, but through the compensation valve. When the pressure compensation function of the valve is set in accordance with the pressure set by the compensation valve, a change-over between the first pump and the second pump will occur automatically in such a manner that the driver will practically not feel such a change-over.

Preferably, the valve is made as a priority valve. The valve is then able to perform an additional function. It can namely supply a working hydraulic, when the steering does not consume the whole amount of hydraulic fluid supplied by the first pump. Such an embodiment is particularly advantageous in trucks and self-propelled vehicles.

Preferably, the valve is acted upon in the closing direction by the pressure at its outlet and in the opening direction by the force of a first spring and a load-sensing pressure ruling at the outlet of the steering valve arrangement, and the compensation valve is acted upon in the closing direction by the pressure at its outlet and in the opening direction by the force of a second spring and the load-sensing pressure, the first spring producing a larger force than the second spring. In this case, it can be ensured that, also when both pumps are active, that is, are supplying a sufficient pressure to the steering valve arrangement, the supply of the steering valve arrangement takes place via the first pump. The first pump is preferably driven by a combustion engine, in particular the vehicle engine, which also ensures the advance of the vehicle. Under the conditions stated, the compensation valve remains closed as long as the first pump can supply a sufficient amount of hydraulic fluid under the required pressure. When, however, for some reason the first pump cannot supply the sufficient flow, the second pump can contribute via the compensation valve. This also applies, when the first pump still works and, in a manner of speaking, the second pump only covers the deficiency of the first pump.

Preferably, the compensation valve ends between a first non-return valve opening in the direction of the steering valve arrangement and the steering valve arrangement in a pipe between the valve and the steering valve arrangement. This ensures in a simple manner that during the supply of the steering valve arrangement the total amount of hydraulic fluid supplied by the second pump can only reach the steering valve arrangement and does not flow through the valve to the first pump. This also prevents errors, which could, for example, occur in the valve.

Preferably, the compensation valve is connected to the first pump via a second non-return valve opening in the direction of the compensation valve. The second non-return valve is connected to the inlet of the compensation valve, which is also connected to the second pump. In this way, it is possible to supply the compensation valve also via the compensation valve, so that malfunctions of the valve can be overcome.

Preferably, the second pump has an electrical drive, the outlet of the second pump being connected to a hydraulic accumulator, the electrical drive being controlled in dependence of the pressure in said tank. Thus, it is possible always to maintain the required pressure at the outlet of the second pump, also when the second pump does not work permanently. This gives a particularly economical and energy-saving operation. Here, another advantage of the second non-return valve occurs. As long as the steering does not consume the total amount of hydraulic fluid from the first pump, the second non-return valve can also lead this fluid to the hydraulic accumulator, which is connected to the inlet of the compensation valve. As long as the pressure in the hydraulic accumulator can be generated by the first pump, the second pump does not have to be activated.

Preferably, the steering valve arrangement comprises one single steering valve. The steering valve is usually so reliable that here no malfunctions must be anticipated. Accordingly, the required reliability of the complete steering can also be ensured, when only one single steering valve is available. In most cases also one single steering motor will be sufficient.

In an alternative embodiment, it is ensured that the steering valve arrangement comprises a primary steering valve and a secondary steering valve, the compensation valve being located between the second pump and the secondary steering valve. When the steering motor arrangement is then controlled via the second steering valve, also the second steering valve will be supplied with the accordingly compensated pressure, the compensation valve ensuring that the pressure drop across the secondary steering valve remains constant. Also in this case the pressure conditions can be set so that the driver will practically not feel a transition from the first pump to the second pump.

Preferably, a stop valve arrangement is provided that interrupts a connection between the first pump and the primary steering valve and releases a connection between the secondary steering valve and the steering motor arrangement in case of a fault. Changing over the stop valve arrangement is a simple way of realising the transition from the primary steering valve to the secondary steering valve or vice versa.

Preferably, the primary steering valve has a first load-sensing circuit acting upon the valve, and the secondary steering valve has a second load-sensing circuit acting upon the compensation valve. In this case, it can be avoided that a fault in a load-sensing circuit is copied to the elements not connected to this load-sensing circuit. On the contrary, both load-sensing circuits work independently of each other and can accordingly control the valve or the compensation valve, respectively, in the desired way.

Preferably, the outlet of the secondary steering valve is connected via a pipe to the inlet of the primary steering valve, a stop valve being located in said inlet. In many cases, it is not necessary to use the secondary steering valve for steering. This particularly applies, when the first pump does not supply sufficient hydraulic fluid, and the second pump has to take over the pressure supply, the primary steering valve yet still working satisfactorily. The secondary steering valve then practically only assumes the function of leading the hydraulic fluid from the second pump through the stop valve to the primary steering valve. Also here the compensation valve is then active, so that the pressure drop across the primary steering valve can be kept constant.

Alternatively, it may be provided that the outlet of the compensation valve is connected via a pipe to the inlet of the primary steering valve, the stop valve being located in said pipe. In this case the secondary steering valve can only be used for steering. When the primary steering valve is still functional and merely the pressure supply switches from the first pump to the second pump, the secondary steering valve does not have to be activated.

It is also advantageous, when the stop valve arrangement comprises a part, which is located between the valve and the primary steering valve. This particularly applies, when the valve is a priority valve. In this case, the part of the stop valve no longer has to be dimensioned for adopting the total amount of hydraulic fluid consumed by the working hydraulics that are connected to the priority valve. On the contrary, the part of the stop valve arrangement only has to handle the share of the hydraulic fluid used for the steering.

Preferably, the stop valve arrangement has several valve functions, which are combined in one single change-over valve. Thus, the change between the primary steering valve and the secondary steering valve can be realised by changing over the change-over valve. It is no longer required to activate several valves at the same time.

Preferably, the change-over valve is made as a slide valve. This is a relatively simple solution, as merely a displacement of the slide is required to open or close the individual paths leading to the primary steering valve or the secondary steering valve, respectively.

Preferably, the steering valve arrangement, the valve, the compensation valve and, in some cases, the stop valve arrangement are combined in one unit. This simplifies the manufacturing. The unit can be pre-assembled and fitted in a vehicle as a complete unit. The combination reduces the space required.

It is preferred that the unit is integrated in or flanged onto the steering motor arrangement. Thus, the pipe paths between the unit and the steering motor arrangement can be kept small. An additional space requirement does practically not occur.

### BRIEF DESCRIPTION OF THE DRAWINGS

In the following the invention is described on the basis of preferred embodiments in connection with the drawings, showing:

FIG. 1 a first embodiment of a hydraulic steering in a schematic view,

FIG. 2 a second embodiment of the hydraulic steering,

FIG. 3 a third embodiment of the hydraulic steering.

### DETAILED DESCRIPTION OF THE PREFERRED EMBODIMENTS

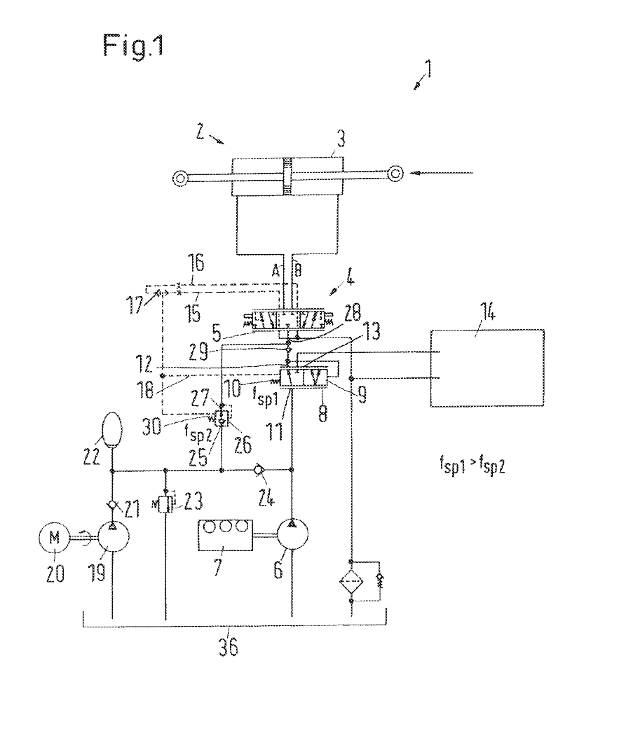

A hydraulic steering 1 shown in a schematic view in FIG. 1 comprises a steering motor arrangement 2 with a steering motor 3. The steering motor 3 is connected to a steering valve arrangement 4, in the embodiment shown having one single steering valve 5. The steering valve 5 is made as a slide valve.

The steering valve 5 is supplied with pressurised hydraulic fluid by a first pump 6. The first pump 6 is driven by a combustion engine, which also drives the vehicle provided with the steering 1. The first pump 6 is connected to a valve 8, here in the form of a priority valve. The valve 8 has a slide 9, which is acted upon in the opening direction by a spring 10. The opening direction is the direction, in which a passage between an inlet 11 of the valve and an outlet 12 of the valve 8 connected to the steering valve is further opened.

In the opposite direction, that is, in the closing direction, the slide 9 is acted upon by the pressure at the outlet 12 of the valve 8. The valve 8 has a second outlet 13 connected to merely schematically shown working hydraulics 14.

In the opening direction the slide 9 is also acted upon by the pressure in the one of the working pipes A, B, which is supplied with pressurised hydraulic fluid via the steering valve 5. For this purpose, two load-sensing pipes 15, 16 are connected to the outlet of the steering valve 5. Both load-sensing pipes 15, 16 are connected to a two-way valve 17. A control pipe 18 extends from the two-way valve 17 to the slide 9 of the valve 8.

Due to this embodiment the valve 8 has two tasks. Firstly, as mentioned, it serves as a priority valve, which gives the steering 1 a higher priority than the working hydraulics 14 with regard to the supply with pressurised hydraulic fluid. Secondly, the valve 8 has a pressure compensation function, that is, the pressure across the steering valve 5 is kept constant so that it corresponds to the force fₛₚ₁ of the spring 10.

A second pump 19 is driven by an electric motor 20. Via a non-return valve 21 it supplies a hydraulic accumulator 22. A pressure control valve 23 ensures that the hydraulic accumulator 22 is not overloaded.

A control device, not shown in detail, turns on the motor 20, when the pressure in the hydraulic accumulator 22 sinks below a predetermined value, and turns the electric motor 20 off, when the pressure in the hydraulic accumulator 22 exceeds a second predetermined value.

The first pump 6 is also connected to the hydraulic accumulator 22 via a non-return valve 24. This makes it possible to fill the hydraulic accumulator 22 with pressurised hydraulic fluid, also when the second pump 19 is not working.

The hydraulic accumulator 22 is connected to an inlet 25 of a compensation valve 26, whose outlet 27 is connected to the steering valve 5. The outlet 27 of the compensation valve 26 ends in a section of the pipe 28 between a non-return valve 29 and the steering valve 5, the non-return valve 29 being located in the pipe between the valve 8 and the steering valve 5 and opening in the direction of the steering valve 5.

In the opening direction the compensation valve 26 is acted upon by the force fₛₚ₂ of a spring 30 and by the load-sensing pressure, that is, the outlet of the two-way valve 17. In the closing direction the compensation valve 26 is acted upon by the pressure at its outlet 27. Also here it applies that the opening direction of the compensation valve 26 is a direction, in which the compensation valve 26 assumes a smaller throttling resistance, whereas the closing direction is the direction, in which the throttling resistance at the compensation valve 26 increases.

The steering 1 now works as follows:

In the “normal” situation the first pump 6 will supply pressurised hydraulic fluid. This hydraulic fluid reaches the steering valve 5 through the valve 8 and the non-return valve 29. From here it is led to the steering motor 3 in dependence of the desired steering direction. As long as no hydraulic fluid is used, it can be led to the working hydraulics 14, when the slide 9 of the valve 8 is displaced to the left by the pressure at the outlet 12 of the valve 8 against the force of the spring 10 and the pressure at the outlet of the two-way valve 17.

With this switching the valve 8 also ensures that the pressure drop across the steering valve 5 is constant. In its function as a priority valve the valve 8 also has the function of a compensation valve.

The force fₛₚ₁ of the spring 10 is larger than the force fₛₚ₂ of the spring 30.

The second motor 19 is only activated, when the pressure in the hydraulic accumulator 22 sinks below a predetermined value. The hydraulic accumulator 22 does not have to be excessively large. It is sufficient, when it contains a volume that can ensure an emergency steering for a few seconds. Usually, for this purpose a volume of a few litres, for example two litres, will be sufficient.

As the force fₛₚ₁ of the spring 10 is larger than the force fₚ₂ of the spring 30, the compensation valve 26 will remain closed, as long as the first pump 6 supplies sufficient pressurised hydraulic fluid.

If the first pump 6 fails, the priority valve 8 is displaced to the shown position, so that the connected working hydraulics 14 is cut off from the supply. At the same time, the vehicle can still be steered by the steering valve 5, as this steering valve 5 now receives hydraulic fluid from the second pump 19 via the compensation valve 26, which also ensures that the pressure across the steering valve 5 remains constant. As the compensation valve 26 is supplied by the same load-sensing pressure from the control pipe 18, the transition of the supply from the first pump 6 to the second pump 19 takes place automatically and is practically not noticed by the driver.

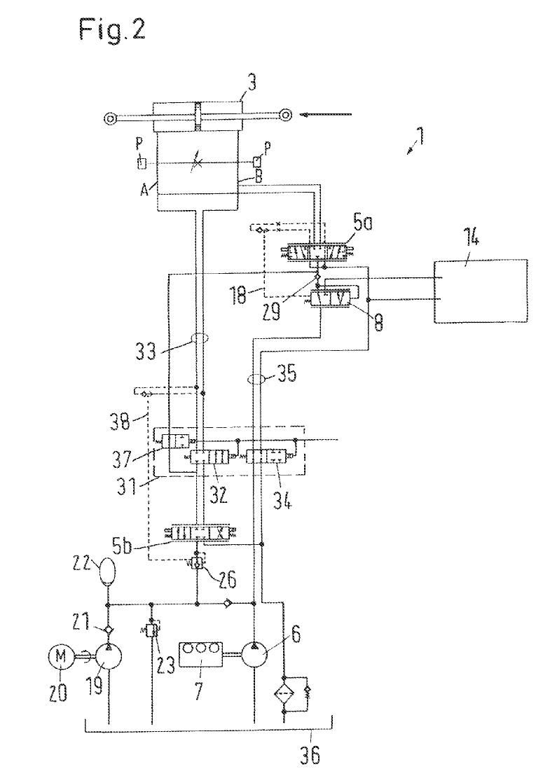

In the steering 1 according to FIG. 1 it is assumed that the steering valve 5 works without faults. When, however, also considering a possible fault in the steering valve, an additional safety is desired, a steering 1 can be used, which is shown in FIG. 2. Here the same elements have the same reference numbers as in FIG. 1.

The steering valve arrangement now has two steering valves 5a, 5b, the steering valve 5a being located in the same position as the steering valve 5 according to FIG. 1. For an explanation of the function of the steering valve 5a, reference is made to the explanation of the steering valve 5 according to FIG. 1. The steering valve 5a is also called “primary” to distinguish it from the secondary steering valve 5b.

The secondary steering valve 5b is connected to the hydraulic accumulator 22 via the compensation valve 26 and to the outlet of the motor 19. Between the secondary steering valve 5b and the steering motor 3 is located a stop valve arrangement 31, interrupting, as shown, or releasing a pipe 33 between the secondary steering valve 5b and the steering motor 3 by means of a part 32, and releasing, as shown, or interrupting a pipe 35 between the primary steering valve 5a and the pump 6 or a tank 36, respectively, by means of another part 34.

Changing over the two parts 32, 34 of the stop valve arrangement 31 also permits changing over the supply from the first pump 6 to the second pump 19.

However, such a change-over is only required in full, if also the primary steering valve 5a is defective. When the primary steering valve 5a still works satisfactorily, a failure of the first pump 6 will only require changing over the secondary steering valve 5b so that the second pump 19 is connected to the stop valve arrangement 31. Further to the two parts 32, 34, the stop valve arrangement 31 comprises a stop valve 37, which connects the second pump 19 to the inlet of the primary steering valve 5a, when the secondary steering valve 5b has changed over. Also in this case, the compensation valve 26 is located between the second pump 19 and the primary steering valve 5a.

The compensation valve 26 is controlled via its own load-sensing circuit 38, which takes a load-sensing signal from the pipe 33. In this way, it is possible to act upon the compensation valve 26 with the pressure ruling at the steering motor 3 without risking that the load-sensing pressure for the compensation valve 26 has been otherwise distorted, particularly by the control pipe 18.

In the embodiment according to FIG. 2 the part 34 of the stop valve arrangement 31 has to be dimensioned so that it can also adopt or manage the amount of hydraulic fluid supplied to the working hydraulics 14.

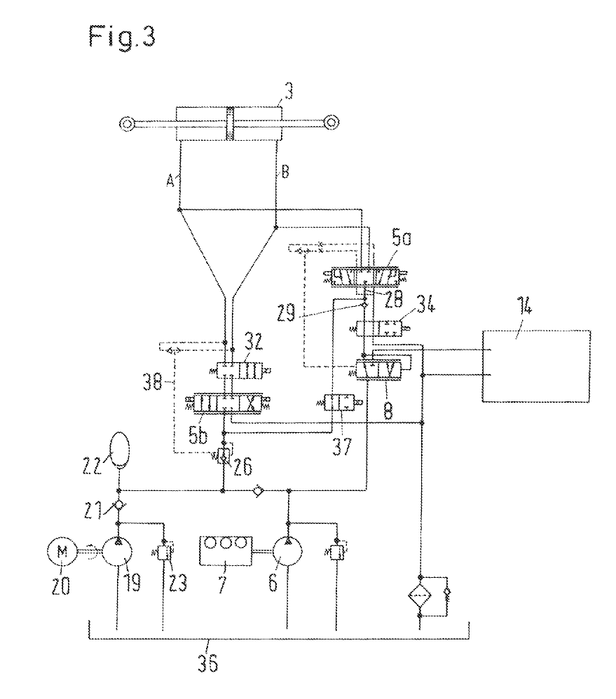

FIG. 3 shows a modified embodiment, in which this is no longer required. Here, the part 34 of the stop valve arrangement is located between the valve 8 and the primary steering valve 5a. Otherwise, the same elements have the same reference numbers as in FIGS. 1 and 2.

Also the part 32 of the stop valve arrangement is now provided in a different place, namely between the secondary steering valve 5b and the steering motor 3. Otherwise, however, the mode of operation is the same.

To avoid having to activate the secondary steering valve 5b with a functional primary steering valve 5a, but failure of the first pump 6, the stop valve 37 is now located in a pipe, which branches off between the compensation valve 26 and the secondary steering valve 5b and leads to the pipe 28 between the non-return valve 29 and the primary steering valve 5a.

As shown also in FIG. 2, the parts 32, 34 of the stop valve arrangement can, in a manner of speaking, be realised in a valve, for example by means of one single valve slide.

All valves, in particular the steering valve 5 or the steering valves 5a, 5b, respectively, the valve 8 and the compensation valve 26 can be assembled in one common valve block. In the embodiments according to FIGS. 2 and 3 also the stop valve arrangement 31 and the stop valve 37 can be integrated in this valve block. Such a unit can then be integrated directly in the steering motor 3 or flanged onto it.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A hydraulic steering with a steering motor arrangement, a steering valve arrangement and a pressure supply comprising a first pump and a second pump, wherein the steering valve arrangement is connected to the first pump through a valve with pressure compensation function and to the second pump through a compensation valve.

2. The steering according to claim 1, wherein the valve is made as a priority valve.

3. The steering according to claim 1, wherein the valve is acted upon in the closing direction by the pressure at its outlet and in the opening direction by the force of a first spring and a load-sensing pressure ruling at the outlet of the steering valve arrangement, and the compensation valve is acted upon in the closing direction by the pressure at its outlet and in the opening direction by the force of a second spring and the load-sensing pressure, the first spring producing a larger force than the second spring.

4. The steering according to claim 3, wherein the compensation valve ends between a first non-return valve opening in the direction of the steering valve arrangement and the steering valve arrangement in a pipe between the valve and the steering valve arrangement.

5. The steering according to claim 3, wherein the compensation valve is connected to the first pump via a second non-return valve opening in the direction of the compensation valve.

6. The steering according to claim 1, wherein the second pump has an electrical drive, the outlet of the second pump being connected to a hydraulic accumulator, the electrical drive being controlled in dependence of the pressure in said tank.

7. The steering according to claim 1, wherein the steering valve arrangement comprises one single steering valve.

8. The steering according to claim 1, wherein the steering valve arrangement comprises a primary steering valve and a secondary steering valve, the compensation valve being located between the second pump and the secondary steering valve.

9. The steering according to claim 8, wherein a stop valve arrangement is provided that interrupts a connection between the first pump and the primary steering valve and releases a connection between the secondary steering valve and the steering motor arrangement in case of a fault.

10. The steering according to claim 8, wherein the primary steering valve has a first load-sensing circuit acting upon the valve, and the secondary steering valve has a second load-sensing circuit acting upon the compensation valve.

11. The steering according to claim 8, wherein the outlet of the secondary steering valve is connected via a pipe to the inlet of the primary steering valve, a stop valve being located in said inlet.

12. The steering according to claim 8, wherein it may be provided that the outlet of the compensation valve is connected via a pipe to the inlet of the primary steering valve, the stop valve being located in said pipe.

13. The steering according to claim 9, wherein the stop valve arrangement comprises a part, which is located between the valve and the primary steering valve.

14. The steering according to claim 9, wherein the stop valve arrangement has several valve functions, which are combined in one single change-over valve.

15. The steering according to claim 14, wherein the change-over valve is made as a slide valve.

16. The steering according to claim 1, wherein the steering valve arrangement, the valve, the compensation valve and, in some cases, the stop valve arrangement are combined in one unit.

17. The steering according to claim 16, wherein the unit is integrated in or flanged onto the steering motor arrangement.
